(19) United States
(12) Patent Application Publication
(10) Pub. No.: US 2014/0136987 A1
(43) Pub. Date: May 15, 2014

(54) GENERATION OF A USER INTERFACE BASED ON CONTACTS

(71) Applicant: APPLE INC., Cupertino, CA (US)

(72) Inventor: Enrique E. RODRIGUEZ, San Jose, CA (US)

(73) Assignee: Apple Inc., Cupertino, CA (US)

(21) Appl. No.: 13/673,924

(22) Filed: Nov. 9, 2012

(51) Int. Cl. G06F 3/048

(52) U.S. Cl. CPC G06F 3/048
USPC 715/752

(57) ABSTRACT

Methods of generating a user interface based on content associated with one or more contacts are provided. In a messaging application, such as email, SMS, chat, or the like, an indication of a message in a conversation (e.g., an icon or some other graphic indicating the receipt of a new message) may be displayed. The conversation can be associated with one or more contacts engaged in the conversation. User input may be received that selects the indication of the message. In response, one or more contacts associated with the conversation may be determined. The conversation may be displayed over a background associated with the one or more contacts. For example, the first conversation may be displayed over a contact image associated with one of the contacts.

### FIELD OF THE DISCLOSURE

This relates generally to generating a user interface based on one or more contacts.

### BACKGROUND OF THE DISCLOSURE

An electronic device can include a display that displays a conversation with one or more contacts. The conversation can include messages to and from the one or more contacts. Although contact names may be displayed, it may not be immediately apparent to a user who the contacts are, and messages may be inadvertently sent to the wrong contacts.

### SUMMARY OF THE DISCLOSURE

This relates to generating a user interface based on content associated with one or more contacts. In a messaging application, such as email, SMS, chat, or the like, an indication of a message in a conversation (e.g., an icon or some other graphic indicating the receipt of a new message) may be displayed. The conversation can be associated with one or more contacts engaged in the conversation. User input may be received that selects the indication of the message. In response, one or more contacts associated with the conversation may be determined. The conversation may be displayed over a background associated with the one or more contacts. For example, the first conversation may be displayed over a contact image associated with one of the contacts. In some examples, multiple contact images may be displayed in the background of the conversation. In this way, the contacts engaged in the conversation can be immediately apparent to the user, which can help to eliminate the possibility of messages being inadvertently sent to the wrong contact.

### BRIEF DESCRIPTION OF THE DRAWINGS

FIG. 1 illustrates a graphical user interface of a messaging application according to examples of the disclosure.

FIG. 2 illustrates a graphical user interface of a messaging application according to examples of the disclosure.

FIG. 3 illustrates a method of generating a user interface based on contacts according to examples of the disclosure.

FIG. 4 illustrates a method of visually indicating a selected contact according to examples of the disclosure.

FIG. 5 is a block diagram illustrating an exemplary API architecture, which may be used in some examples of the disclosure.

FIG. 6 illustrates an exemplary software stack of an API according to examples of the disclosure.

FIG. 7 is a block diagram illustrating exemplary interactions between the touch screen and the other components of the device according to examples of the disclosure.

FIG. 8 is a block diagram illustrating an example of a system architecture that may be embodied within any portable or non-portable device according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

Various examples relate to generating a user interface based on content associated with one or more contacts. In a messaging application, such as email, SMS, chat, or the like, an indication of a message in a conversation (e.g., an icon or some other graphic indicating the receipt of a new message) may be displayed. The conversation can be associated with one or more contacts engaged in the conversation. User input may be received that selects the indication of the message. In response, one or more contacts associated with the conversation may be determined. The conversation may be displayed over a background associated with the one or more contacts. For example, the first conversation may be displayed over a contact image associated with one of the contacts. In some examples, multiple contact images may be displayed in the background of the conversation. In this way, the contacts engaged in the conversation can be immediately apparent to the user, which can help to eliminate the possibility of messages being inadvertently sent to the wrong contact.

Although examples disclosed herein may be described and illustrated herein primarily in terms of a mobile messaging applications, it should be understood that the examples are not so limited, but are additionally applicable to messaging applications generally, and to any application that involves displaying content associated with one or more contacts.

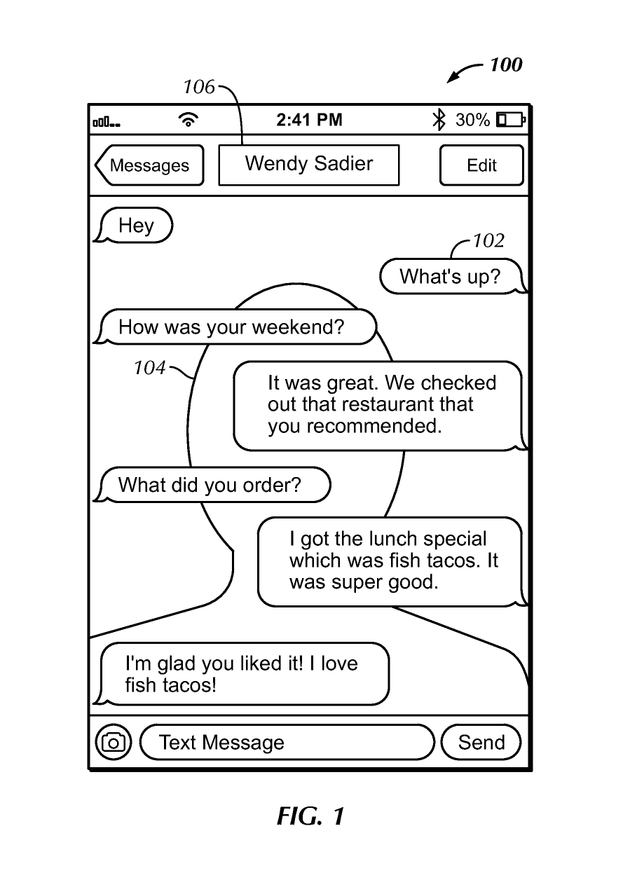

FIG. 1 illustrates a graphical user interface (GUI) 100 of a messaging application according to examples of the disclosure. The GUI 100 can include content 102 associated with a conversation of the messaging application. For example, FIG. 1 illustrates text messages associated with a conversation. However, in other examples, content associated with a conversation can include images, emails, emoticons, hyperlinks, and attachments, among other possibilities.

One or more contacts can be associated with the conversation. For example, the associated contacts can include users that are engaged in the conversation. The contacts may include any sender or recipient of a message in the conversation. FIG. 1 illustrates a conversation associated with a contact “Wendy Sadier.” The GUI 100 can include the names 106 of one or more contacts associated with the conversation. The content 102 can be displayed over a background 104 associated with one or more contacts associated with the conversation. For example, FIG. 1 illustrates text messages displayed over a contact image associated with the contact “Wendy Sadier.” In some examples, the background can include a color associated with the contact. Alternatively, the background can include a generic contact image associated with the stored gender of the contact. For example, male contacts may have a generic contact image with short hair, whereas female contacts may have a generic contact image with long hair.

In some examples, the background 104 can be modified in one or more ways to keep user focus on the content 102 of the conversation. For example, a contact image can be dimmed or alpha-blended with a background color. Alpha-blending can include making the contact image translucent and blending the image with a background color. Although FIG. 1 illustrates a contact image occupying a large portion of the background 104, the contact image may be made smaller in the background, tiled on the background, or stretched to fill the entire image. In some examples, a contact image may be cropped and positioned on the background 104.

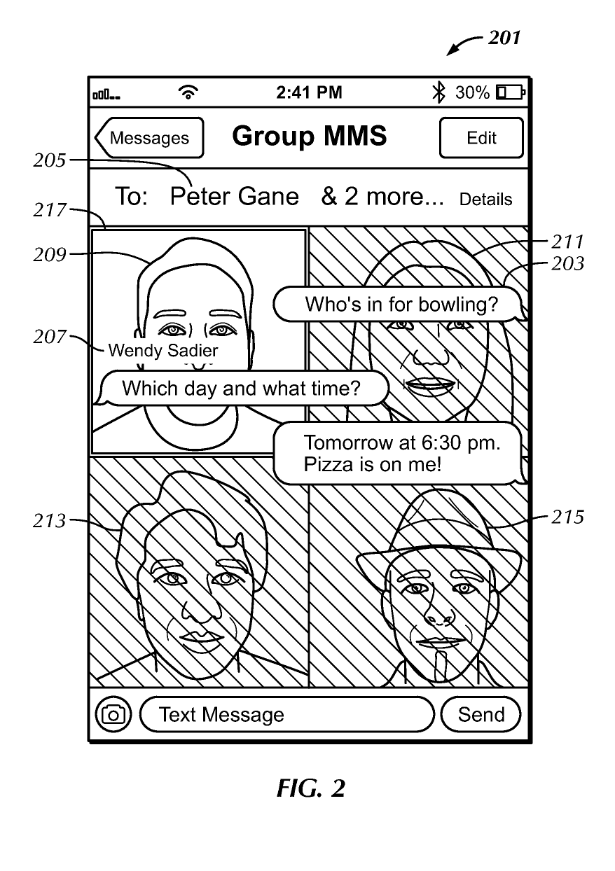

FIG. 2 illustrates a GUI 201 of a messaging application according to examples of the disclosure. The GUI 201 can include content 203 associated with a conversation of the messaging application. One or more contacts may be associated with the conversation, and FIG. 2 illustrates four contacts associated with the conversation. Names 205 of some or all of the associated contacts can be displayed in the GUI. Additionally or alternatively, one or more messages can be labeled with a contact name 207 of the sender of a message. The content 203 can be displayed over a background associated with the one or more contacts of the conversation. For example, four contact images 209, 211, 213, and 215 can each be associated with one of the contacts. Contact image 209 can be a photo or other representation of a first contact of the one or more contacts, and contact image 211 can be a photo of a second contact of the one or more contacts. In some examples, the contact images can be tiled in the background, as illustrated in FIG. 2. Additionally, the size of each image can be adjusted so that all the contact images can fit on the interface. Other arrangements of the contact images are also possible.

In some examples, a sender of a most recent message in the conversation can be automatically selected and an indication of the selected sender can be displayed. For example, the GUI can include a box 217 around the selected contact image 209 as illustrated in FIG. 2. The selected contact image can have a higher alpha-blending value than the other contact images, such that the other contact images appear dimmed in relation to the selected contact image. In some examples, the selected contact image can appear in color and the other contact images can appear in grayscale. FIG. 2 illustrates contact images 211, 213, and 215 with diagonal lines to represent that those images are not selected and may appear dimmed or in grayscale, for example. In some examples, only the selected contact image may be displayed in the background, and the background could change as a new message is received to correspond to the sender of the new message. In some examples, thumbnails of one or more of the contacts of the conversation can be displayed in a cover flow or carousel layout, and the selected contact image of the selected sender can be displayed, centered and/or larger than the thumbnails. In one or more of the above examples, the GUI can display an animation as each new message is received to transition from one selected contact image to another.

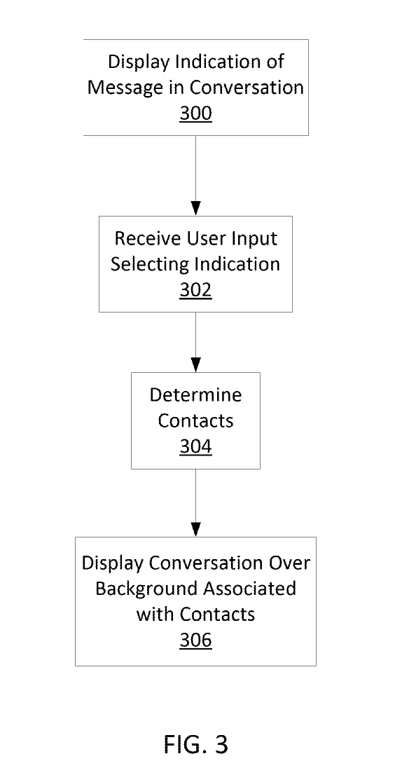

FIG. 3 illustrates a method of generating a user interface based on contacts according to examples of the disclosure. An indication of a message in a conversation can be displayed (300). In some examples, the indication can include an icon or some other graphic indicating a new message. For example, the indication can include a contact image associated with the sender of the message or some other contact associated with the conversation. The indication may include a contact name or some text of the message, among other possibilities. In some examples, the indication may be a notification that the message has been received. The indication may also be part of a list of messages in a messaging application.

User input selecting the indication of the message can be received (302). In some examples, user input selecting the indication of the message can be received on a touch-sensitive surface. Additionally, the user input can be received through a pointing device, such as a mouse, a keyboard, voice recognition, and/or gaze recognition, among other possibilities.

One or more contacts associated with the conversation can be determined (304). Contacts associated with the conversation can include any sender or recipient of any message in the conversation. Determining the contacts can include obtaining a list of one or more contacts from a memory. Alternatively, determining the contacts can include receiving a list of one or more contacts along with a received message in the conversation. In some examples, contact information may be received and the one or more contacts may be determined based on the contact information. For example, contacts may be determined based on a list of one or more email addresses or telephone numbers.

The conversation may be displayed over a background associated with the one or more contacts (306). Displaying the conversation may include displaying some or all of the content associated with the conversation. For example, displaying the conversation may include displaying one or more text messages of the conversation. The content may be displayed over a background associated with the one or more contacts. The background can include a contact image associated with one of the contacts. As discussed above, the background may alternatively include a color associated with one of the contacts and/or a generic contact image associated with the stored gender of one of the contacts. As discussed with reference to FIG. 2, the background may include multiple images, each associated with a different one of the contacts.

In some examples, displaying the conversation over the background associated with the one or more contacts can include displaying a transition from the display of the indication of the message to the display of the conversation over the background. For example, if the indication includes a contact image associated with the sender of the message, the transition can include an animation of the contact image growing larger to become the background over which the contact is displayed. If the indication includes a contact name and/or text of the message, the transition can include an animation of the contact name and/or text of the message moving and/or changing size to be positioned in the displayed conversation.

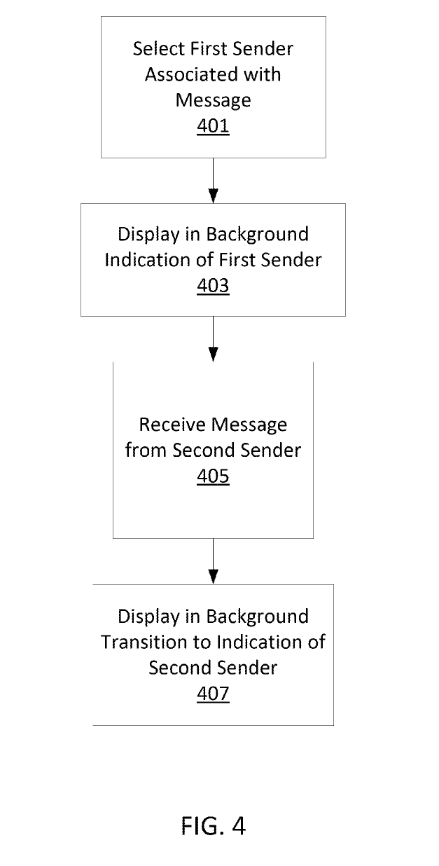

FIG. 4 illustrates a method of visually indicating a selected contact according to examples of the disclosure. In a conversation with multiple contacts, a visual indication of a sender of a most recent message can help a user follow the conversation. A first sender associated with a message in a conversation can be selected (401). For example, on receipt of a message, the sender of the message can be automatically selected. Alternatively, upon receipt of user input selecting an indication of a message in a conversation, a sender associated with the indicated message can be selected.

An indication of the first sender can be displayed in the background (403). Multiple examples are discussed above. For example, displaying an indication of a selected sender can include displaying a box around the contact image associated with the sender. In some examples, displaying an indication of a selected sender can include displaying thumbnails of one or more of the contacts of the conversation in a cover flow or carousel layout, and the contact image associated with the selected sender can be displayed centered and/or larger than the thumbnails.

A message can be received from a second sender, and the second sender can be automatically selected in response (405). Then, a transition from an indication of the first sender to an indication of the second sender can be displayed in the background (407). Displaying the transition can include displaying an animation of an indicator, such as a box around a contact image, moving from the first sender to the second sender. In some examples, displaying the transition can include displaying an animation of a contact image associated with the first sender growing smaller and/or moving from the center of the interface. Displaying the transition can also include displaying an animation of a contact image associated with the second sender growing larger and/or moving to the center of the interface.

Although the examples provided above primarily describe contact images appearing in the background, in other examples the contact images may appear in other areas of the display, such as adjacent to the messages (but above the background image), within the messages, in perimeter areas or other fields of the display, and the like.

The examples discussed above can be implemented in one or more Application Programming Interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component.

The above-described features can be implemented as part of an application program interface (API) that can allow it to be incorporated into different applications (e.g., spreadsheet apps) utilizing touch input as an input mechanism. An API can allow a developer of an API-calling component (which may be a third party developer) to leverage specified features, such as those described above, provided by an API-implementing component. There may be one API-calling component or there may be more than one such component. An API can be a source code interface that a computer system or program library provides in order to support requests for services from an application. An operating system (OS) can have multiple APIs to allow applications running on the OS to call one or more of those APIs, and a service (such as a program library) can have multiple APIs to allow an application that uses the service to call one or more of those APIs. An API can be specified in terms of a programming language that can be interpreted or compiled when an application is built.

In some examples, the API-implementing component may provide more than one API, each providing a different view of the functionality implemented by the API-implementing component, or with different aspects that access different aspects of the functionality implemented by the API-implementing component. For example, one API of an API-implementing component can provide a first set of functions and can be exposed to third party developers, and another API of the API-implementing component can be hidden (not exposed) and provide a subset of the first set of functions and also provide another set of functions, such as testing or debugging functions which are not in the first set of functions. In other examples the API-implementing component may itself call one or more other components via an underlying API and thus be both an API-calling component and an API-implementing component.

An API defines the language and parameters that API-calling components use when accessing and using specified features of the API-implementing component. For example, an API-calling component accesses the specified features of the API-implementing component through one or more API calls or invocations (embodied for example by function or method calls) exposed by the API and passes data and control information using parameters via the API calls or invocations. The API-implementing component may return a value through the API in response to an API call from an API-calling component. While the API defines the syntax and result of an API call (e.g., how to invoke the API call and what the API call does), the API may not reveal how the API call accomplishes the function specified by the API call. Various API calls are transferred via the one or more application programming interfaces between the calling (API-calling component) and an API-implementing component. Transferring the API calls may include issuing, initiating, invoking, calling, receiving, returning, or responding to the function calls or messages; in other words, transferring can describe actions by either of the API-calling component or the API-implementing component. The function calls or other invocations of the API may send or receive one or more parameters through a parameter list or other structure. A parameter can be a constant, key, data structure, object, object class, variable, data type, pointer, array, list or a pointer to a function or method or another way to reference a data or other item to be passed via the API.

Furthermore, data types or classes may be provided by the API and implemented by the API-implementing component. Thus, the API-calling component may declare variables, use pointers to, use or instantiate constant values of such types or classes by using definitions provided in the API.

Generally, an API can be used to access a service or data provided by the API-implementing component or to initiate performance of an operation or computation provided by the API-implementing component. By way of example, the API-implementing component and the API-calling component may each be any one of an operating system, a library, a device driver, an API, an application program, or other module (it should be understood that the API-implementing component and the API-calling component may be the same or different type of module from each other). API-implementing components may in some cases be embodied at least in part in firmware, microcode, or other hardware logic. In some examples, an API may allow a client program to use the services provided by a Software Development Kit (SDK) library. In other examples an application or other client program may use an API provided by an Application Framework. In these examples the application or client program may incorporate calls to functions or methods provided by the SDK and provided by the API or use data types or objects defined in the SDK and provided by the API. An Application Framework may in these examples provide a main event loop for a program that responds to various events defined by the Framework. The API allows the application to specify the events and the responses to the events using the Application Framework. In some implementations, an API call can report to an application the capabilities or state of a hardware device, including those related to aspects such as input capabilities and state, output capabilities and state, processing capability, power state, storage capacity and state, communications capability, etc., and the API may be implemented in part by firmware, microcode, or other low level logic that executes in part on the hardware component.

The API-calling component may be a local component (i.e., on the same data processing system as the API-implementing component) or a remote component (i.e., on a different data processing system from the API-implementing component) that communicates with the API-implementing component through the API over a network. It should be understood that an API-implementing component may also act as an API-calling component (i.e., it may make API calls to an API exposed by a different API-implementing component) and an API-calling component may also act as an API-implementing component by implementing an API that is exposed to a different API-calling component.

The API may allow multiple API-calling components written in different programming languages to communicate with the API-implementing component (thus the API may include features for translating calls and returns between the API-implementing component and the API-calling component); however the API may be implemented in terms of a specific programming language. An API-calling component can, in one example, call APIs from different providers such as a set of APIs from an OS provider and another set of APIs from a plug-in provider and another set of APIs from another provider (e.g. the provider of a software library) or creator of the another set of APIs.

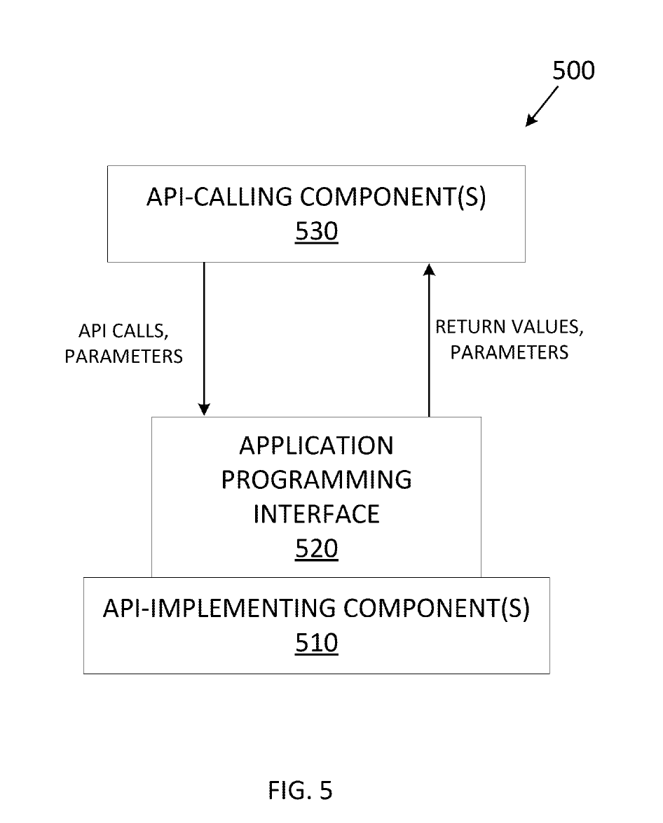

FIG. 5 is a block diagram illustrating an exemplary API architecture, which may be used in some examples of the disclosure. As shown in FIG. 5, the API architecture 500 includes the API-implementing component 510 (e.g., an operating system, a library, a device driver, an API, an application program, software or other module) that implements the API 520. The API 520 specifies one or more functions, methods, classes, objects, protocols, data structures, formats and/or other features of the API-implementing component that may be used by the API-calling component 530. The API 520 can specify at least one calling convention that specifies how a function in the API-implementing component receives parameters from the API-calling component and how the function returns a result to the API-calling component. The API-calling component 530 (e.g., an operating system, a library, a device driver, an API, an application program, software or other module), makes API calls through the API 520 to access and use the features of the API-implementing component 510 that are specified by the API 520. The API-implementing component 510 may return a value through the API 520 to the API-calling component 530 in response to an API call.

It will be appreciated that the API-implementing component 510 may include additional functions, methods, classes, data structures, and/or other features that are not specified through the API 520 and are not available to the API-calling component 530. It should be understood that the API-calling component 530 may be on the same system as the API-implementing component 510 or may be located remotely and accesses the API-implementing component 510 using the API 520 over a network. While FIG. 5 illustrates a single API-calling component 530 interacting with the API 520, it should be understood that other API-calling components, which may be written in different languages (or the same language) than the API-calling component 530, may use the API 520.

The API-implementing component 510, the API 520, and the API-calling component 530 may be stored in a non-transitory machine-readable storage medium, which includes any mechanism for storing information in a form readable by a machine (e.g., a computer or other data processing system). For example, a machine-readable medium includes magnetic disks, optical disks, random access memory; read only memory, flash memory devices, etc.

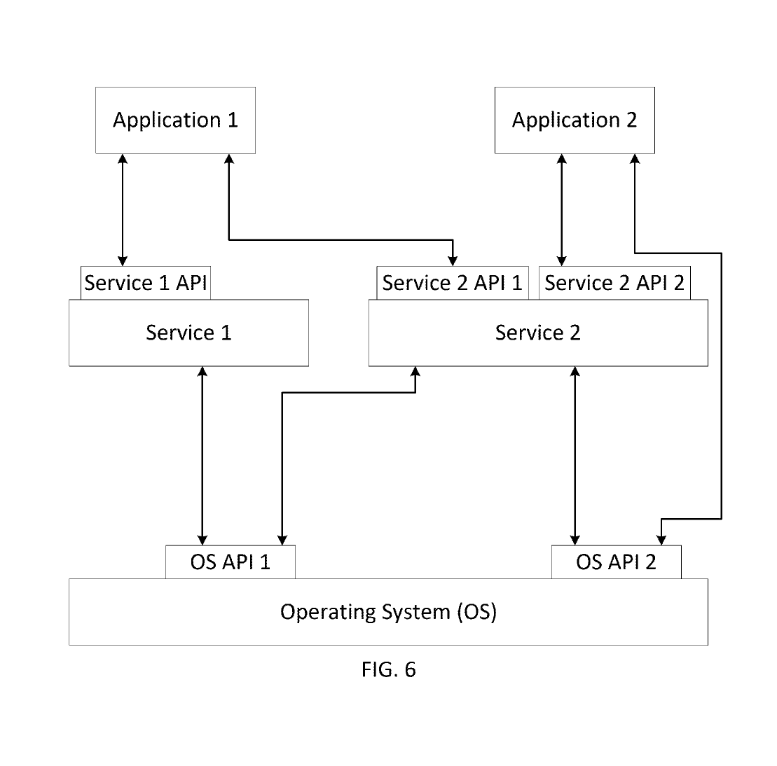

In the exemplary software stack shown in FIG. 6, applications can make calls to Services A or B using several Service APIs and to Operating System (OS) using several OS APIs. Services A and B can make calls to OS using several OS APIs.

Note that the Service 2 has two APIs, one of which (Service 2 API 1) receives calls from and returns values to Application 1 and the other (Service 2 API 2) receives calls from and returns values to Application 2. Service 1 (which can be, for example, a software library) makes calls to and receives returned values from OS API 1, and Service 2 (which can be, for example, a software library) makes calls to and receives returned values from both OS API 1 and OS API 2. Application 2 makes calls to and receives returned values from OS API 2.

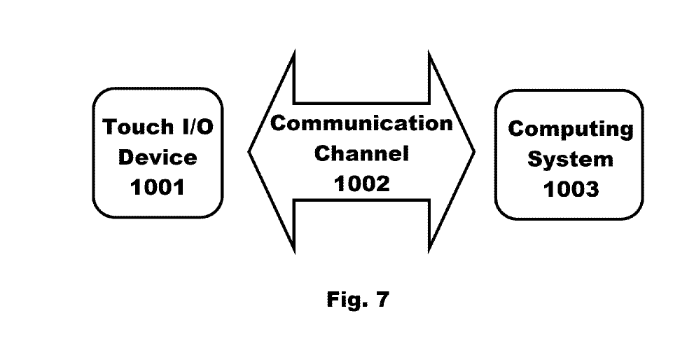

FIG. 7 is a block diagram illustrating exemplary interactions between the touch screen and the other components of the device. Described examples may include touch I/O device 1001 that can receive touch input for interacting with computing system 1003 via wired or wireless communication channel 1002. Touch I/O device 1001 may be used to provide user input to computing system 1003 in lieu of or in combination with other input devices such as a keyboard, mouse, etc. One or more touch I/O devices 1001 may be used for providing user input to computing system 1003. Touch I/O device 1001 may be an integral part of computing system 1003 (e.g., touch screen on a smartphone or a tablet PC) or may be separate from computing system 1003.

Touch I/O device 1001 may include a touch sensitive panel which is wholly or partially transparent, semitransparent, non-transparent, opaque or any combination thereof. Touch I/O device 1001 may be embodied as a touch screen, touch pad, a touch screen functioning as a touch pad (e.g., a touch screen replacing the touchpad of a laptop), a touch screen or touchpad combined or incorporated with any other input device (e.g., a touch screen or touchpad disposed on a keyboard) or any multi-dimensional object having a touch sensitive surface for receiving touch input.

In one example, touch I/O device 1001 embodied as a touch screen may include a transparent and/or semitransparent touch sensitive panel partially or wholly positioned over at least a portion of a display. According to this example, touch I/O device 1001 functions to display graphical data transmitted from computing system 1003 (and/or another source) and also functions to receive user input. In other examples, touch I/O device 1001 may be embodied as an integrated touch screen where touch sensitive components/devices are integral with display components/devices. In still other examples a touch screen may be used as a supplemental or additional display screen for displaying supplemental or the same graphical data as a primary display and to receive touch input.

Touch I/O device 1001 may be configured to detect the location of one or more touches or near touches on device 1001 based on capacitive, resistive, optical, acoustic, inductive, mechanical, chemical measurements, or any phenomena that can be measured with respect to the occurrences of the one or more touches or near touches in proximity to device 1001. Software, hardware, firmware or any combination thereof may be used to process the measurements of the detected touches to identify and track one or more gestures. A gesture may correspond to stationary or non-stationary, single or multiple, touches or near touches on touch I/O device 1001. A gesture may be performed by moving one or more fingers or other objects in a particular manner on touch I/O device 1001 such as tapping, pressing, rocking, scrubbing, twisting, changing orientation, pressing with varying pressure and the like at essentially the same time, contiguously, or consecutively. A gesture may be characterized by, but is not limited to a pinching, sliding, swiping, rotating, flexing, dragging, or tapping motion between or with any other finger or fingers. A single gesture may be performed with one or more hands, by one or more users, or any combination thereof.

Computing system 1003 may drive a display with graphical data to display a graphical user interface (GUI). The GUI may be configured to receive touch input via touch I/O device 1001. Embodied as a touch screen, touch I/O device 1001 may display the GUI. Alternatively, the GUI may be displayed on a display separate from touch I/O device 1001. The GUI may include graphical elements displayed at particular locations within the interface. Graphical elements may include but are not limited to a variety of displayed virtual input devices including virtual scroll wheels, a virtual keyboard, virtual knobs, virtual buttons, any virtual UI, and the like. A user may perform gestures at one or more particular locations on touch I/O device 1001 which may be associated with the graphical elements of the GUI. In other examples, the user may perform gestures at one or more locations that are independent of the locations of graphical elements of the GUI. Gestures performed on touch I/O device 1001 may directly or indirectly manipulate, control, modify, move, actuate, initiate or generally affect graphical elements such as cursors, icons, media files, lists, text, all or portions of images, or the like within the GUI. For instance, in the case of a touch screen, a user may directly interact with a graphical element by performing a gesture over the graphical element on the touch screen. Alternatively, a touch pad generally provides indirect interaction. Gestures may also affect non-displayed GUI elements (e.g., causing user interfaces to appear) or may affect other actions within computing system 1003 (e.g., affect a state or mode of a GUI, application, or operating system). Gestures may or may not be performed on touch I/O device 1001 in conjunction with a displayed cursor. For instance, in the case in which gestures are performed on a touchpad, a cursor (or pointer) may be displayed on a display screen or touch screen and the cursor may be controlled via touch input on the touchpad to interact with graphical objects on the display screen. In other examples in which gestures are performed directly on a touch screen, a user may interact directly with objects on the touch screen, with or without a cursor or pointer being displayed on the touch screen.

Feedback may be provided to the user via communication channel 1002 in response to or based on the touch or near touches on touch I/O device 1001. Feedback may be transmitted optically, mechanically, electrically, olfactory, acoustically, or the like or any combination thereof and in a variable or non-variable manner.

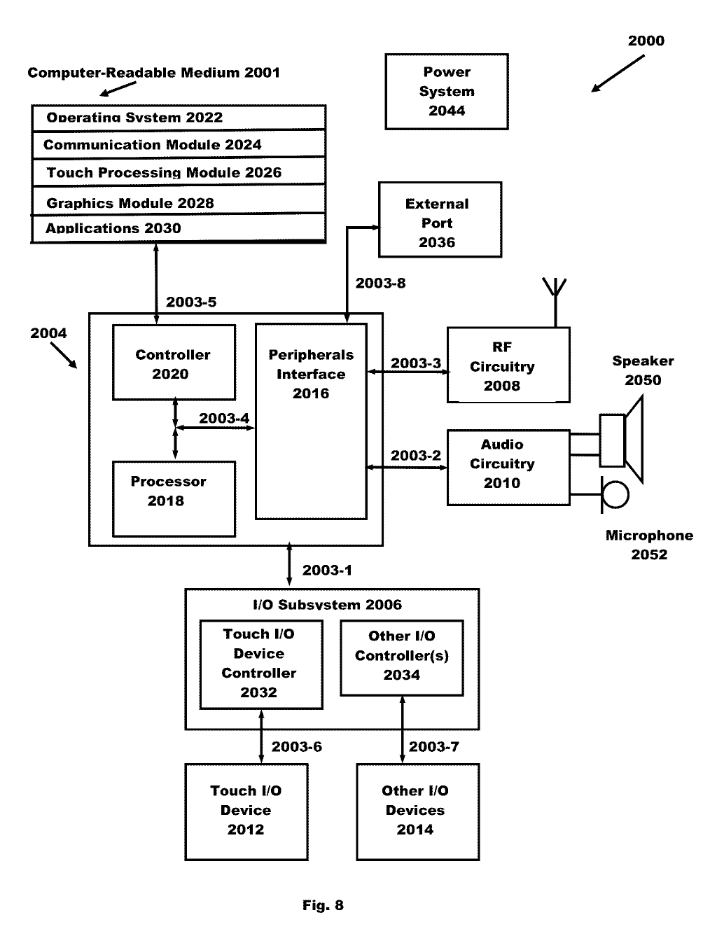

Attention is now directed towards examples of a system architecture that may be embodied within any portable or non-portable device including but not limited to a communication device (e.g. mobile phone, smart phone), a multi-media device (e.g., MP3 player, TV, radio), a portable or handheld computer (e.g., tablet, netbook, laptop), a desktop computer, an All-In-One desktop, a peripheral device, or any other system or device adaptable to the inclusion of system architecture 2000, including combinations of two or more of these types of devices. FIG. 8 is a block diagram of one example of system 2000 that generally includes one or more computer-readable mediums 2001, processing system 2004, I/O subsystem 2006, radio frequency (RF) circuitry 2008, audio circuitry 2010, and gaze detection circuitry 2011. These components may be coupled by one or more communication buses or signal lines 2003.

It should be apparent that the architecture shown in FIG. 8 is only one example architecture of system 2000, and that system 2000 could have more or fewer components than shown, or a different configuration of components. The various components shown in FIG. 8 can be implemented in hardware, software, firmware or any combination thereof, including one or more signal processing and/or application specific integrated circuits.

RF circuitry 2008 is used to send and receive information over a wireless link or network to one or more other devices and includes well-known circuitry for performing this function. RF circuitry 2008 and audio circuitry 2010 are coupled to processing system 2004 via peripherals interface 2016. Interface 2016 includes various known components for establishing and maintaining communication between peripherals and processing system 2004. Audio circuitry 2010 is coupled to audio speaker 2050 and microphone 2052 and includes known circuitry for processing voice signals received from interface 2016 to enable a user to communicate in real-time with other users. In some examples, audio circuitry 2010 includes a headphone jack (not shown).

Peripherals interface 2016 couples the input and output peripherals of the system to processor 2018 and computer-readable medium 2001. One or more processors 2018 communicate with one or more computer-readable mediums 2001 via controller 2020. Computer-readable medium 2001 can be any device or medium that can store code and/or data for use by one or more processors 2018. Medium 2001 can include a memory hierarchy, including but not limited to cache, main memory and secondary memory. The memory hierarchy can be implemented using any combination of RAM (e.g., SRAM, DRAM, DDRAM), ROM, FLASH, magnetic and/or optical storage devices, such as disk drives, magnetic tape, CDs (compact disks) and DVDs (digital video discs). Medium 2001 may also include a transmission medium for carrying information-bearing signals indicative of computer instructions or data (with or without a carrier wave upon which the signals are modulated). For example, the transmission medium may include a communications network, including but not limited to the Internet (also referred to as the World Wide Web), intranet(s), Local Area Networks (LANs), Wide Local Area Networks (WLANs), Storage Area Networks (SANs), Metropolitan Area Networks (MAN) and the like.

One or more processors 2018 run various software components stored in medium 2001 to perform various functions for system 2000. In some examples, the software components include operating system 2022, communication module (or set of instructions) 2024, touch processing module (or set of instructions) 2026, graphics module (or set of instructions) 2028, and one or more applications (or set of instructions) 2030. Each of these modules and above noted applications correspond to a set of instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules may be combined or otherwise re-arranged in various examples. In some examples, medium 2001 may store a subset of the modules and data structures identified above. Furthermore, medium 2001 may store additional modules and data structures not described above.

Operating system 2022 includes various procedures, sets of instructions, software components and/or drivers for controlling and managing general system tasks (e.g., memory management, storage device control, power management, etc.) and facilitates communication between various hardware and software components.

Communication module 2024 facilitates communication with other devices over one or more external ports 2036 or via RF circuitry 2008 and includes various software components for handling data received from RF circuitry 2008 and/or external port 2036.

Graphics module 2028 includes various known software components for rendering, animating and displaying graphical objects on a display surface. In examples in which touch I/O device 2012 is a touch sensitive display (e.g., touch screen), graphics module 2028 includes components for rendering, displaying, and animating objects on the touch sensitive display.

One or more applications 2030 can include any applications installed on system 2000, including without limitation, a browser, address book, contact list, email, instant messaging, word processing, keyboard emulation, widgets, JAVA-enabled applications, encryption, digital rights management, voice recognition, voice replication, location determination capability (such as that provided by the global positioning system (GPS)), a music player, etc.

Touch processing module 2026 includes various software components for performing various tasks associated with touch I/O device 2012 including but not limited to receiving and processing touch input received from I/O device 2012 via touch I/O device controller 2032.

I/O subsystem 2006 is coupled to touch I/O device 2012 and one or more other I/O devices 2014 for controlling or performing various functions. Touch I/O device 2012 communicates with processing system 2004 via touch I/O device controller 2032, which includes various components for processing user touch input (e.g., scanning hardware). One or more other input controllers 2034 receives/sends electrical signals from/to other I/O devices 2014. Other I/O devices 2014 may include physical buttons, dials, slider switches, sticks, keyboards, touch pads, additional display screens, or any combination thereof.

If embodied as a touch screen, touch I/O device 2012 displays visual output to the user in a GUI. The visual output may include text, graphics, video, and any combination thereof. Some or all of the visual output may correspond to user-interface objects. Touch I/O device 2012 forms a touch-sensitive surface that accepts touch input from the user. Touch I/O device 2012 and touch screen controller 2032 (along with any associated modules and/or sets of instructions in medium 2001) detects and tracks touches or near touches (and any movement or release of the touch) on touch I/O device 2012 and converts the detected touch input into interaction with graphical objects, such as one or more user-interface objects. In the case in which device 2012 is embodied as a touch screen, the user can directly interact with graphical objects that are displayed on the touch screen. Alternatively, in the case in which device 2012 is embodied as a touch device other than a touch screen (e.g., a touch pad), the user may indirectly interact with graphical objects that are displayed on a separate display screen embodied as I/O device 2014.

Touch I/O device 2012 may be analogous to the multi-touch sensitive surface described in the following U.S. Pat. Nos. 6,323,846 (Westerman et al.), 6,570,557 (Westerman et al.), and/or 6,677,932 (Westerman), and/or U.S. Patent Publication 2002/0015024A1, each of which is hereby incorporated by reference.

Examples in which touch I/O device 2012 is a touch screen, the touch screen may use LCD (liquid crystal display) technology, LPD (light emitting polymer display) technology, OLED (organic LED), or OEL (organic electro luminescence), although other display technologies may be used in other examples.

Feedback may be provided by touch I/O device 2012 based on the user's touch input as well as a state or states of what is being displayed and/or of the computing system. Feedback may be transmitted optically (e.g., light signal or displayed image), mechanically (e.g., haptic feedback, touch feedback, force feedback, or the like), electrically (e.g., electrical stimulation), olfactory, acoustically (e.g., beep or the like), or the like or any combination thereof and in a variable or non-variable manner.

System 2000 also includes power system 2044 for powering the various hardware components and may include a power management system, one or more power sources, a recharging system, a power failure detection circuit, a power converter or inverter, a power status indicator and any other components typically associated with the generation, management and distribution of power in portable devices.

In some examples, peripherals interface 2016, one or more processors 2018, and memory controller 2020 may be implemented on a single chip, such as processing system 2004. In some other examples, they may be implemented on separate chips.

Examples of the disclosure can be advantageous in allowing users to easily and quickly recognize which contacts are involved in a conversation and which contact sent the most recent message.

In some examples, a computer-implemented method is disclosed. The method can include displaying an indication of a message in a conversation; receiving user input selecting the indication; determining one or more contacts associated with the conversation; and displaying the conversation over a background associated with the one or more contacts. Additionally or alternatively to one or more of the examples disclosed above, the method can further include selecting a first sender associated with the message; and displaying in the background an indication of the first sender. Additionally or alternatively to one or more of the examples disclosed above, the method can further include receiving a message from a second sender; selecting the second sender; and displaying in the background a transition from the indication of the first sender to an indication of the second sender. Additionally or alternatively to one or more of the examples disclosed above, displaying a transition can include at least one of a contact image associated with the first sender growing smaller and a contact image associated with the second sender growing larger. Additionally or alternatively to one or more of the examples disclosed above, displaying the conversation over the background associated with the one or more contacts can include displaying the conversation over a plurality of contact images, each associated with a different one of the one or more contacts. Additionally or alternatively to one or more of the examples disclosed above, displaying the conversation over the plurality of contact images can include displaying the plurality of contact images tiled in the background. Additionally or alternatively to one or more of the examples disclosed above, displaying the conversation over the background associated with the one or more contacts can include displaying the conversation over an image associated with a gender of one of the one or more contacts. Additionally or alternatively to one or more of the examples disclosed above, the method can further include modifying a contact image associated with one of the one or more contacts; wherein displaying the conversation over the background associated with the one or more contacts can include displaying the conversation over the modified contact image. Additionally or alternatively to one or more of the examples disclosed above, the indication of the message can include a contact image associated with a sender of the message. Additionally or alternatively to one or more of the examples disclosed above, displaying the conversation over the background associated with the one or more contacts can include displaying a transition from the display of the indication of the message to the display of the conversation over the background. Additionally or alternatively to one or more of the examples disclosed above, the indication of the message can include a contact image associated with a sender of the message, and the transition can include an animation of the contact image growing larger to become the background.

In some examples, an electronic device is disclosed. The electronic device can include a display; a processor to execute instructions; and a memory coupled with the processor to store instructions, which when executed by the processor, cause the processor to perform operations to generate an application programming interface (API) that allows an API-calling component to perform the following operations: displaying an indication of a message in a conversation; receiving user input selecting the indication; determining one or more contacts associated with the conversation; and displaying the conversation over a background associated with the one or more contacts. Additionally or alternatively to one or more of the examples disclosed above, the operations can further include selecting a first sender associated with the message; and displaying in the background an indication of the first sender. Additionally or alternatively to one or more of the examples disclosed above, the operations can further include receiving a message from a second sender; selecting the second sender; and displaying in the background a transition from the indication of the first sender to an indication of the second sender. Additionally or alternatively to one or more of the examples disclosed above, displaying a transition can include at least one of a contact image associated with the first sender growing smaller and a contact image associated with the second sender growing larger. Additionally or alternatively to one or more of the examples disclosed above, displaying the conversation over the background associated with the one or more contacts can include displaying the conversation over a plurality of contact images, each associated with a different one of the one or more contacts. Additionally or alternatively to one or more of the examples disclosed above, displaying the conversation over the plurality of contact images can include displaying the plurality of contact images tiled in the background. Additionally or alternatively to one or more of the examples disclosed above, displaying the conversation over the background associated with the one or more contacts can include displaying the conversation over an image associated with a gender of one of the one or more contacts. Additionally or alternatively to one or more of the examples disclosed above, the operations can further include modifying a contact image associated with one of the one or more contacts; wherein displaying the conversation over the background associated with the one or more contacts can include displaying the conversation over the modified contact image. Additionally or alternatively to one or more of the examples disclosed above, the indication of the message can include a contact image associated with a sender of the message. Additionally or alternatively to one or more of the examples disclosed above, displaying the conversation over the background associated with the one or more contacts can include displaying a transition from the display of the indication of the message to the display of the conversation over the background. Additionally or alternatively to one or more of the examples disclosed above, the indication of the message can include a contact image associated with a sender of the message, and the transition can include an animation of the contact image growing larger to become the background.

Although the disclosed examples have been fully described with reference to the accompanying drawings, it is to be noted that various changes and modifications will become apparent to those skilled in the art. Such changes and modifications are to be understood as being included within the scope of the disclosed examples as defined by the appended claims.

What is claimed is:

1. A method of a computing device including a display, the method comprising:
displaying an indication of a message in a conversation;
receiving user input selecting the indication;
determining one or more contacts associated with the conversation; and
displaying the conversation over a background associated with the one or more contacts.

2. The method of claim 1, further comprising:
selecting a first sender associated with the message; and
displaying in the background an indication of the first sender.

3. The method of claim 2, further comprising:
receiving a message from a second sender;
selecting the second sender; and
displaying in the background a transition from the indication of the first sender to an indication of the second sender.

4. The method of claim 3, wherein displaying a transition includes at least one of a contact image associated with the first sender growing smaller and a contact image associated with the second sender growing larger.

5. The method of claim 1, wherein displaying the conversation over the background associated with the one or more contacts includes displaying the conversation over a plurality of contact images, each associated with a different one of the one or more contacts.

6. The method of claim 5, wherein displaying the conversation over the plurality of contact images includes displaying the plurality of contact images tiled in the background.

7. The method of claim 1, wherein displaying the conversation over the background associated with the one or more contacts includes displaying the conversation over an image associated with a gender of one of the one or more contacts.

8. The method of claim 1, further comprising:
modifying a contact image associated with one of the one or more contacts;
wherein displaying the conversation over the background associated with the one or more contacts includes displaying the conversation over the modified contact image.

9. The method of claim 1, wherein the indication of the message includes a contact image associated with a sender of the message.

10. The method of claim 1, wherein displaying the conversation over the background associated with the one or more contacts includes displaying a transition from the display of the indication of the message to the display of the conversation over the background.

11. The method of claim 10, wherein the indication of the message includes a contact image associated with a sender of the message, and the transition includes an animation of the contact image growing larger to become the background.

12. An electronic device, comprising:
a display;
a processor to execute instructions; and
a memory coupled with the processor to store instructions, which when executed by the processor, cause the processor to perform operations to generate an application programming interface (API) that allows an API-calling component to perform the following operations:
displaying an indication of a message in a conversation;
receiving user input selecting the indication;
determining one or more contacts associated with the conversation; and
displaying the conversation over a background associated with the one or more contacts.

13. The electronic device of claim 12, the operations further comprising:
selecting a first sender associated with the message; and
displaying in the background an indication of the first sender.

14. The electronic device of claim 13, the operations further comprising:
receiving a message from a second sender;
selecting the second sender; and
displaying in the background a transition from the indication of the first sender to an indication of the second sender.

15. The electronic device of claim 4, wherein displaying a transition includes at least one of a contact image associated with the first sender growing smaller and a contact image associated with the second sender growing larger.

16. The electronic device of claim 12, wherein displaying the conversation over the background associated with the one or more contacts includes displaying the conversation over a plurality of contact images, each associated with a different one of the one or more contacts.

17. The electronic device of claim 16, wherein displaying the conversation over the plurality of contact images includes displaying the plurality of contact images tiled in the background.

18. The electronic device of claim 12, wherein displaying the conversation over the background associated with the one or more contacts includes displaying the conversation over an image associated with a gender of one of the one or more contacts.

19. The electronic device of claim 12, the operations further comprising:
modifying a contact image associated with one of the one or more contacts;
wherein displaying the conversation over the background associated with the one or more contacts includes displaying the conversation over the modified contact image.

20. The electronic device of claim 12, wherein the indication of the message includes a contact image associated with a sender of the message.
